(19) United States
(12) Patent Application Publication
(10) Pub. No.: US 2013/0223087 A1
(43) Pub. Date: Aug. 29, 2013

(54) FITTING PART FOR A VEHICLE INTERIOR, COMPRISING A LIGHTING SURFACE

(71) Applicants: Wolfgang Mueller, Wermelskirchen (DE); Frank Pilger, Bergisch Gladback (DE)

(72) Inventors: Wolfgang Mueller, Wermelskirchen (DE); Frank Pilger, Bergisch Gladback (DE)

(73) Assignee: JOHNSON CONTROLS GMBH, BURSCHEID (DE)

(21) Appl. No.: 13/702,875

(22) PCT Filed: Jun. 9, 2011
(86) PCT No.: PCT/EP11/02824

§ 371 Date: May 18, 2013

(30) Foreign Application Priority Data
Jun. 9, 2010 (DE) 10 2010 023 247.5

(51) Int. Cl. F21S 8/10

(52) U.S. Cl. CPC F21S 48/00
USPC 362/511

(57) ABSTRACT

The invention relates to a fitting part for a vehicle interior, comprising a lighting surface that having a shaped body on which is disposed a light guide. The light guide has a covering layer. The shaped body has at least in some sections of its edge region an indentation which accommodates a light source.

### BACKGROUND

The present invention relates to a fitting part for the interior of a vehicle, comprising a luminous surface which consists of a molded body on which a light conductor which is provided with a cover layer is arranged.

Such fitting parts are known from e.g. DE 103 41 253 A1. Fitting parts according to the prior art are often disadvantageous in that they are not dimensionally stable, in that the light source is unprotected and/or in that they have edge regions with sharp borders.

### SUMMARY

It was therefore the object of the present invention to provide a fitting part that does not have the disadvantages of the prior art.

The object is achieved by a fitting part for the interior of a vehicle, comprising a light source which consists of a molded body on which a light conductor which is provided with a cover layer is arranged. The molded body is, at least in sections of the edge region thereof, provided with an indentation which holds a light source.

The present invention relates to a fitting part for the interior of a vehicle. Such a fitting part generally is a covering part or the instrument panel. By way of example, the fitting part is a door lining or the roof liner. In general, these fitting parts have a base material, which is provided with at least a trim layer, but often also with a padding layer which is preferably arranged between the trim layer and the base material. The base material can have a multilayered design.

According to the invention, this fitting part has a luminous surface, in particular for highlighting certain regions of the fitting part and/or for enabling or improving the illumination of the interior of the vehicle. According to the invention, this luminous surface consists of a molded body, which generally serves as base layer. This molded body is often produced by forming a two-dimensional material and/or by casting or injection molding. A light conductor is arranged on this molded body. The light conductor is preferably cohesively connected to the molded body, more particularly adhesively bonded to the latter. According to the invention, the light conductor is a planar, flexible light conductor, and so the luminous surface can be comparatively large and need not be planar since the flexible light conductor matches the contour of the molded plate. As a result of its flexibility, the light conductor experiences a certain amount of mechanical load without being damaged. In the case of a break, for example in an accident situation, sharp edges are not created as a result of the flexibility. Between the light conductor and the interior, i.e. on the visible side of the fitting part, the light conductor is, according to the invention, provided with a cover layer over the whole surface thereof, said cover layer preferably protruding over the edge of the light conductor. This cover layer is at least a trim layer, for example leather, fabric or Alcantara upholstery, which particularly preferably has a soft touch, i.e. in which a padding layer is preferably also provided between the trim layer and the conductor. The light emitted by the light conductor passes through the cover layer and then lightens the interior of the vehicle. The trim layer, the padding layer and the light conductor are preferably connected to one another cohesively, more particularly by adhesive bonding.

According to the invention, the molded body is now, at least in sections of the edge region thereof, provided with an indentation which holds the light source. A first advantage of this indentation is that it lends stability to the molded body; secondly, however, it also improves the transition between the molded body and the components adjoining thereon such that this transition is pleasing to the eye but without sharp edges. As a result of the fact that the light source is provided in the indentation, the fitting part according to the invention has very space-saving design and the light source is protected.

The indentation is preferably embodied as a groove, particularly preferably as a continuous groove extending around the whole edge region of the molded body. The light source can be as long as the whole groove or as long as part of the groove. It is possible to arrange a plurality of light sources in the groove, it being possible to operate these light sources together or independently of one another. The individual light sources can emit light with different wavelengths and/or with different intensity. By way of example, the light source can be an LED, an OLED and/or an incandescent bulb. Each light source can be connected to one or more electric circuits. A plurality of light sources can be connected to a common electric circuit or to separate electric circuits.

The indentation preferably has at least one cutout for coupling the light from the light source into the light conductor. By way of example, the cutout is a slit.

The light source is preferably provided in a housing, which is arranged in the indentation and preferably connected thereto in a cohesive fashion, more particularly adhesively bonded therein.

In another preferred embodiment, the light source is arranged directly on the edge of the indentation, preferably in an interlocking fashion, more particularly connected thereto by adhesive bonding.

However, the light source is preferably provided such that it can be replaced in a simple manner.

### DRAWINGS

In the following text, the invention will be explained on the basis of FIGS. 1 to 5. However, these explanations are merely exemplary and do not restrict the general inventive concept.

FIG. 1 shows an embodiment of the fitting part according to the invention, in this case a door lining.

FIG. 2A shows details of the fitting part.

FIG. 2B shows a housing for a light source.

FIG. 3 shows the indentation of the molded body.

FIG. 4 shows a further illustration of the housing.

FIG. 5 shows the housing in the indentation of the fitting part.

### DETAILED DESCRIPTION

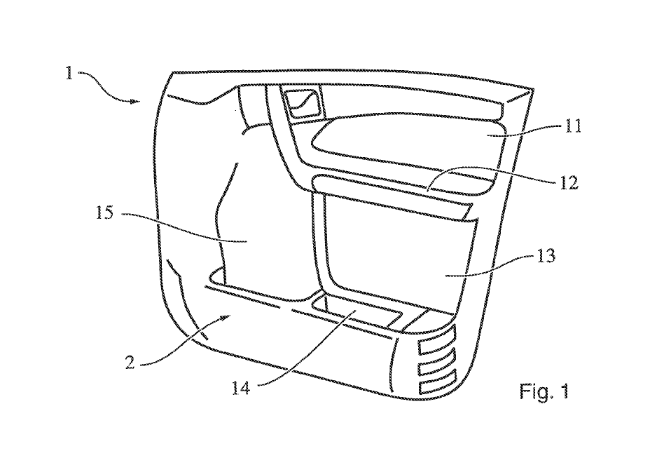

FIG. 1 shows the visible side 2 of an embodiment of the fitting part 1 according to the invention, in this case a door lining. This door lining has a door handle 12 and a storage compartment 14. Furthermore, the door lining has a first 11, a second 13 and a third surface part 15, which can respectively represent a luminous surface 11, 13, 15.

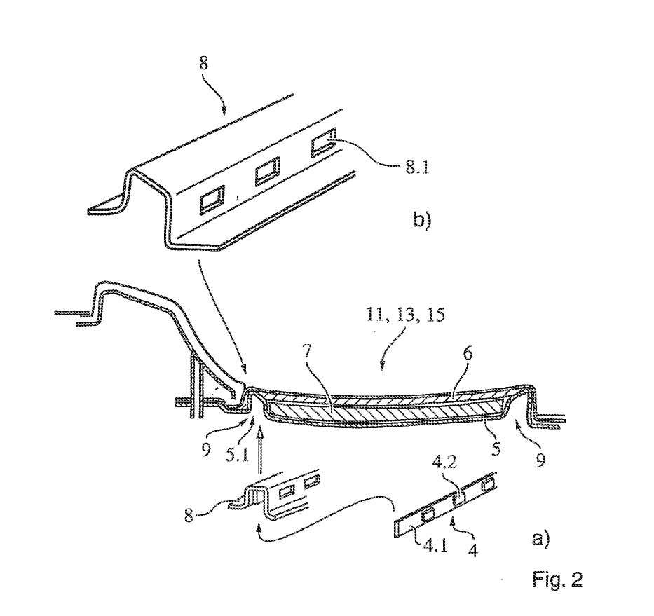

FIG. 2a shows details of the fitting part 1, more particularly of the luminous surface 11, 13, 15. On the rear side, the latter has a molded part 5 which, in the present case, has a pan-shaped design and, encircling it in the edge region 9 thereof, an indentation 5.1. This indentation has a rounded design, particularly in the edge region thereof facing the passenger compartment, so that it has no sharp edges. Further molded parts adjoin the molded part 5 in the edge region. Arranged within the molded part 5 there is a planar, flexible light conductor 7, which is covered by a cover layer 6 in the direction of the passenger interior and adhesively bonded to the molded part 5. As shown by the indicated exploded view, a light source 4, in this case LEDs 4.2 which are arranged on a printed circuit board 4.1, is arranged in a housing 8, which in turn is inserted into the gap 5.1. As can be gathered from FIG. 2b in particular, the housing 8 has cutouts 8.1 in the region of the LEDs 4.2, through which cutouts light beams are routed in the direction of the light conductor. In the present case, the size of the cutout corresponds to the area of the LEDs or OLEDs. A person skilled in the art understands that the molded body 5, at least in the region of the cutout 8.1, likewise has openings, e.g. slits, through which the light from the light source 4 is coupled into the light conductor 7.

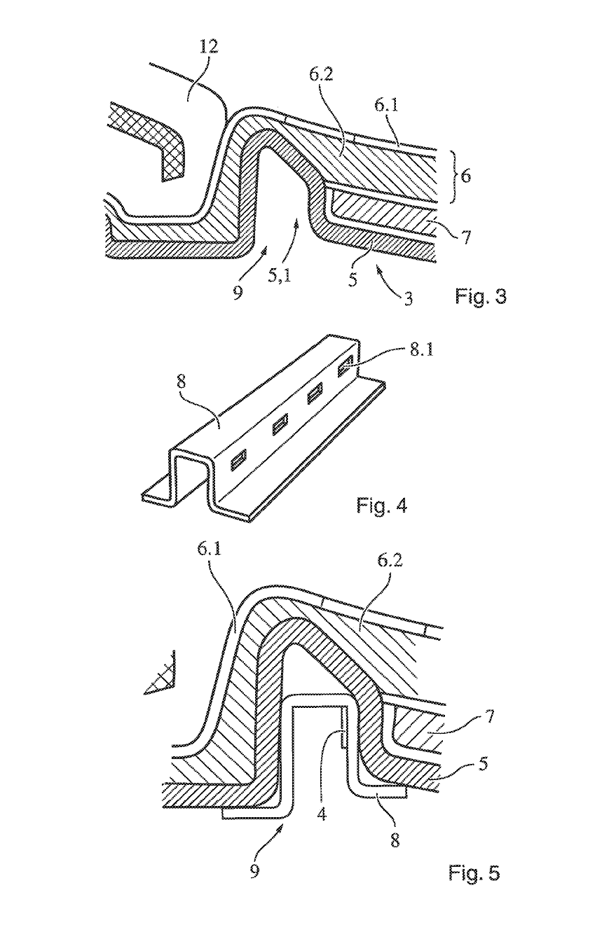

FIG. 3 shows details of the edge region 9 of the molded body 5 of the fitting part according to the invention. It can clearly be identified that an indentation 5.1, which substantially has a groove-shaped design, is provided on the rear side thereof, with the base of the groove being provided at an angle in the present case and the edge regions being rounded in order, firstly, to obtain a good transition to at least one adjacent component but, secondly, not to create dangerous sharp edges. It can furthermore be identified in this illustration that the cover layer 6 has both a trim layer 6.1, for example made of leather, fabric or Alcantara, and a padding layer 6.2, which in turn reduces the risk of injury and lends the fitting part according to the invention a so-called soft touch, even in the region of the luminous surface.

FIG. 4 once again shows the housing 8 with the cutout 8.1, which, as illustrated in FIG. 5, is installed into the cutout 5.1; in this case, it is adhesively bonded therein.

It is furthermore possible to identify the light source 4 in the illustration as per FIG. 5.

### LIST OF REFERENCE SYMBOLS

1 Fitting part

2 Visible side

3 Rear side

4 Light source

4.1 Printed circuit board

4.2 LED, OLED

5 Molded part, central door part

5.1 Indentation, groove

6 Cover layer

6.1 Trim layer

6.2 Padding layer

7 Light conductor

8 Housing

8.1 Cutout in the housing

9 Edge

11 First surface part, luminous surface

12 Door handle

13 Second surface part, luminous surface

14 Storage compartment

15 Third surface part, luminous surface

1. A fitting part for the interior of a vehicle, comprising a luminous surface comprising a molded body and a light conductor with a cover layer wherein the molded body has, at least in sections of an edge region thereof, an indentation which holds the light source.

2. The fitting part as claimed in claim 1, wherein the indentation is embodied as a groove.

3. The fitting part as claimed in claim 1, wherein the indentation a cutout for coupling the light from the light source into the light conductor.

4. The fitting part as claimed in claim 1, wherein the light source is provided in a housing arranged in the indentation.

5. The fitting part as claimed in claim 1, wherein the light source is arranged directly on the indentation.

6. The fitting part as claimed in claim 1, wherein the cover layer comprises a trim layer and a padding layer.

7. The fitting part as claimed in claim 1, wherein the cover layer protrudes over the edge region.

8. The fitting part as claimed in claim 1, wherein the luminous surface is adjoined by further surfaces which cover the edge region.

9. The fitting part as claimed in claim 5, wherein the light source is arranged on the indentation in interlocking fashion.
